(19) United States
(12) Patent Application Publication
(10) Pub. No.: US 2026/0121348 A1
(43) Pub. Date: Apr. 30, 2026

(54) APPARATUS FOR CONNECTOR FASTENING AND BATTERY CONTROL UNIT

(71) Applicant: SAMSUNG SDI CO., LTD., Yongin-si (KR)

(72) Inventor: Hyungho KIM, Yongin-si (KR)

(21) Appl. No.: 19/360,141

(22) Filed: Oct. 16, 2025

(30) Foreign Application Priority Data
Oct. 24, 2024 (KR) 10-2024-0146940

(51) Int. Cl. H01R 13/631; H01M 10/42; H01R 43/26

(52) U.S. Cl. CPC H01R 13/631; H01M 10/425; H01R 43/26; H01M 2010/4271

(57) ABSTRACT

An apparatus for connector fastening includes a panel, a connector attached to the panel, and a connector guide groove adjacent to the connector, the connector guide groove being in the panel, wherein the connector guide groove includes a bottom surface recessed inward from a surface of the panel, a guide wall connecting the bottom surface to the surface of the panel, and an end portion connected to the guide wall, the end portion being closest to the connector.

### CROSS-REFERENCE TO RELATED APPLICATION

The present application claims priority to and the benefit of Korean Patent Application No. 10-2024-0146940, filed on Oct. 24, 2024 in the Korean Intellectual Property Office, the entire disclosure of which is incorporated herein by reference.

### BACKGROUND

### 1. Field

The present disclosure relates to an apparatus for connector fastening and a battery control unit.

### 2. Description of the Related Art

Different from primary batteries that are not designed to be charged, secondary batteries are designed to be discharged and recharged. Low-capacity secondary batteries are used in small portable electronic devices, such as smart phones, feature phones, notebook computers, digital cameras, and camcorders, while large-capacity secondary batteries are widely used as power sources for driving motors, such as of hybrid vehicles or electric vehicles, and for power storage. These batteries include an electrode assembly having a positive electrode and a negative electrode, a case housing the electrode assembly, and terminals connected to the positive electrode and the negative electrode.

A plurality of batteries are combined to form an energy storage system with expanded voltage and/or current capacity. The energy storage system may include battery modules/packs used for vehicles or electrical appliances.

The above information disclosed in this Background section is for enhancement of understanding of the background of the present disclosure, and therefore, it may contain information that does not constitute the related art.

### SUMMARY

Embodiments include an apparatus for connector fastening, including a panel, a connector attached to the panel, and a connector guide groove adjacent to the connector, the connector guide groove being in the panel, wherein the connector guide groove includes a bottom surface recessed inward from a surface of the panel, a guide wall connecting the bottom surface to the surface of the panel, and an end portion connected to the guide wall, the end portion being closest to the connector.

The connector may include a first connector and a second connector, and the connector guide groove may be between the first connector and the second connector.

The panel, the connector, and the connector guide groove may be in a battery control unit.

The bottom surface and the guide wall of the connector guide groove may form a quadrangular shape.

A boundary between the guide wall of the connector guide groove and the panel may include a chamfering machined portion.

The apparatus for connector fastening may further include a shock-absorbing layer applied to the bottom surface of the connector guide groove.

The end portion of the connector guide groove may have a quadrangular shape.

The guide wall of the connector guide groove may include an inclined portion.

The guide wall of the connector guide groove may include a stepped portion where the guide wall meets the end portion.

The guide wall of the connector guide groove may include an uneven portion.

Embodiments include a battery control unit, including a connector attached to a panel, and a connector guide groove adjacent to the connector, the connector guide groove being in the panel, wherein the connector guide groove includes a bottom surface recessed inward from a surface of the panel, a guide wall connecting the bottom surface to the surface of the panel, and an end portion connected to the guide wall, the end portion being closest to the connector relative to other parts of the connector guide groove.

The connector may include a first connector and a second connector, and the connector guide groove may be between the first connector and the second connector.

The bottom surface and the guide wall of the connector guide groove form a quadrangular space.

A boundary of the guide wall of the connector guide groove may include a chamfering machined portion.

The battery control unit may further include a shock-absorbing layer on the bottom surface of the connector guide groove.

The end portion of the connector guide groove may have a quadrangular shape.

The guide wall of the connector guide groove may include an inclined portion.

The guide wall of the connector guide groove may include a stepped portion where the guide wall meets the end portion.

The guide wall of the connector guide groove may include an uneven portion.

Embodiments include a connector mounting panel, including a connector, and a connector guide groove adjacent to the connector, wherein the connector guide groove includes a bottom surface recessed inward from a surface, a guide wall connecting the bottom surface to the surface, and an end portion connected to the guide wall, the end portion being closest to the connector.

Aspects and features of the present disclosure are not limited to those described above, and other aspects and features not specifically mentioned herein will be clearly understood by those of ordinary skill in the art from the description of the present disclosure below.

### BRIEF DESCRIPTION OF THE DRAWINGS

Features will become apparent to those of ordinary skill in the art by describing in detail exemplary embodiments with reference to the attached drawings, in which:

FIG. 1 schematically shows a pouch-type battery according to one or more embodiments of the present disclosure;

FIG. 2 is a cross-sectional view of a cylindrical battery according to one or more embodiments of the present disclosure;

FIG. 3A is a top perspective view showing an exterior of a prismatic battery according to one or more embodiments of the present disclosure;

FIG. 3B is a cross-sectional view along line I-I′ in FIG. 3A;

FIG. 4 is an exemplary view of a battery module in which batteries are arranged according to one or more embodiments of the present disclosure;

FIG. 5 illustrates a schematic configuration of an energy storage system according to one or more embodiments of the present disclosure;

FIG. 6 is a plan view illustrating the inside of a container type energy storage system according to one or more embodiments of the present disclosure;

FIG. 7 illustrates a rear panel of a battery control unit (BCU) according to one or more embodiments of the present disclosure;

FIG. 8 is a transverse cross-sectional view along line A-A′ of a connector guide groove of FIG. 7;

FIG. 9 is a transverse cross-sectional view of a connector guide groove according to one or more other embodiments of the present disclosure;

FIG. 10 is a transverse cross-sectional view of a connector guide groove according to one or more other embodiments of the present disclosure;

FIG. 11 is a front view of a connector guide groove according to one or more other embodiments of the present disclosure;

FIG. 12 is a specific configuration diagram for describing the connector guide groove of FIG. 11 in detail; and

FIG. 13 is a view for describing the operation of the connector guide groove of FIG. 11.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those of ordinary skill in the art.

In the drawing figures, the dimensions of layers and regions may be exaggerated for clarity of illustration. The same reference numerals designate the same elements. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

The terms or words used in the present specification and claims are not to be narrowly interpreted according to their general or dictionary meanings and should be interpreted as having meanings and concepts that are consistent with the technical idea of the present disclosure on the basis of the principle that an inventor can be his/her own lexicographer to appropriately define concepts of terms to describe his/her embodiments in the best way.

The embodiments described in this specification and the configurations shown in the drawings are only some embodiments of the present disclosure and do not represent all of the aspects, features, and embodiments of the present disclosure. Accordingly, it should be understood that there may be various equivalents and modifications that can replace or modify one or more embodiments or features therein described herein at the time of filing this application.

It will be understood that if an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, if a first element is described as being “coupled” or “connected” to a second element, the first element may be directly coupled or connected to the second element or the first element may be indirectly coupled or connected to the second element via one or more intervening elements.

As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same.” Thus, the phrase “substantially the same” may include a case having a deviation that is considered low in the art, for example, a deviation of 5% or less. In addition, if a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may contact the upper (or lower) surface of the element, and another element may also be interposed between the element and the arbitrary element located on (or under) the element.

In addition, it will be understood that if a component is referred to as being “linked,” “coupled,” or “connected” to another component, the elements may be directly “coupled,” “linked” or “connected” to each other, or another component may be “interposed” between the components.”

Throughout the specification, if “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terminology used herein is for the purpose of describing embodiments of the present disclosure and is not intended to limit the present disclosure.

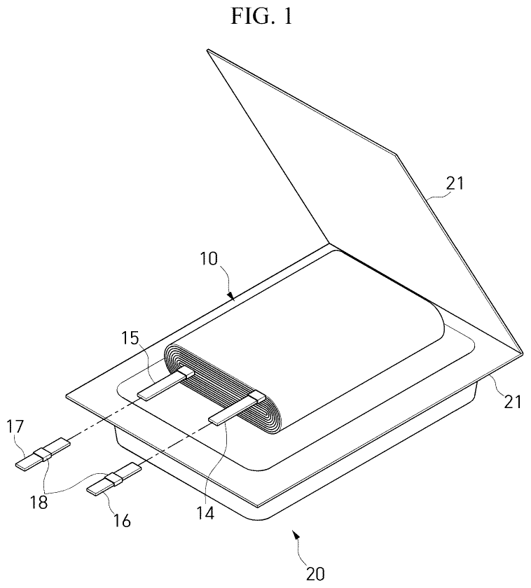

FIG. 1 schematically illustrates a pouch-type battery that can be used in an energy storage device (ESS) according to one or more embodiments of the present disclosure.

The pouch-type secondary battery includes an electrode assembly 10 and a pouch 20 that accommodates the electrode assembly 10.

The first electrode tab 14 and the second electrode tab 15 of the electrode assembly 10 may be electrically connected to respective external first and second terminal leads 16 and 17 by welding. Each of the first terminal lead 16 and the second terminal lead 17 may be attached with a tab film 18 for insulation from the pouch 20.

The pouch 20 may be sealed by having sealing parts 21 at the edges thereof come into contact with each other while accommodating the electrode assembly 10 therein, in which case the sealing may be achieved with the tab film 18 interposed between the sealing parts 21. The sealing parts 21 of the pouch 20 may each be made of a thermal fusion material that generally has weak adhesion to metal. Thus, it may be fused to the pouch 20 by interposing the thin tab film 18 between the sealing parts 21.

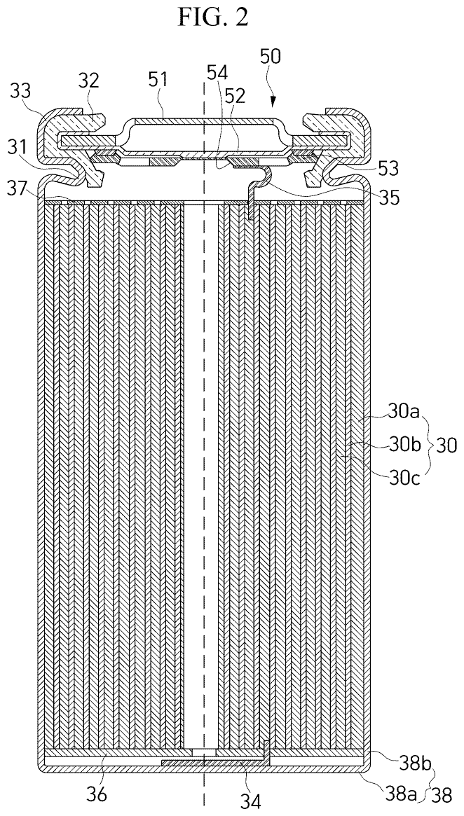

FIG. 2 is a cross-sectional view of a cylindrical battery that can be used in an energy storage device according to one or more embodiments of the present disclosure. The cylindrical battery includes an electrode assembly 30, a case 38 that accommodates the electrode assembly 30 and an electrolyte therein, a cap assembly 50 that is coupled to an opening of the case 38 to seal it, and an insulating plate 37 that is positioned between the electrode assembly 30 and the cap assembly 50 inside the case 38.

The electrode assembly 30 may include a separator 30b and a first electrode 30c and a second electrode 30a positioned with the separator interposed therebetween and may be wound in a jelly-roll shape.

The first electrode 30c includes a first substrate and a first active material layer on the first substrate. A first lead tab 35 may extend outwardly from a first uncoated portion of the first substrate where the first active material layer is not located, and the first lead tab 35 may be electrically connected to the cap assembly 50.

The second electrode 30a includes a second substrate and a second active material layer on the second substrate. A second lead tab 34 may extend outwardly from a second uncoated portion of the second substrate where the second active material layer is not located, and the second lead tab 34 may be electrically connected to the case 38. The first lead tab 35 and the second lead tab 34 may extend in opposite directions.

The first electrode 30c may act as a positive electrode. In such an embodiment, the first substrate may be made of, for example, an aluminum foil, and the first active material layer may include, for example, a transition metal oxide. The second electrode 30a may act as a negative electrode. In such an embodiment, the second substrate may be made of, for example, a copper foil or a nickel foil, and the second active material layer may include graphite, for example.

The separator 30b prevents a short circuit between the first electrode 30c and the second electrode 30a while allowing movement of lithium ions therebetween. The separator 32 may be made of, for example, a polyethylene film, a polypropylene film, a polyethylene-polypropylene film, or the like.

The case 38 accommodates the electrode assembly 30 and the electrolyte, and, together with the cap assembly 50, forms the external appearance of the battery. The case 38 may have a substantially cylindrical body portion 38b and a bottom portion 38a connected to one side of the body portion 38b. A beading part 31 (e.g., a bead) deformed inwardly may be formed in the body portion 38b, and a crimping part 33 (e.g., a crimp) bent inwardly may be formed at an open end of the body portion 38b.

The beading part 31 can reduce or prevent movement of the electrode assembly 30 inside the case 38 and can facilitate seating of the gasket 32 and the cap assembly 50.

The crimping part 33 may firmly fix the cap assembly 32 by pressing the edge of the case 38 against the gasket 32. The case 38 may be formed of iron plated with nickel, for example.

The cap assembly 50 may be fixed to the inside of the crimping part 33 by a gasket 32 to seal the case 38. The cap assembly 50 may include a cap up 51, a safety vent 52, a cap down 53, an insulating member, and a sub plate 54 but may be modified in various ways.

The cap up 51 may be positioned at the uppermost part of the cap assembly 50 (in the orientation shown). The cap up 51 may include a terminal part that protrudes upwardly and is connected to an external circuit, and an outlet for discharging gas may be arranged around the terminal part.

The safety vent 52 may be located under the cap up 51. The safety vent 52 may include a protrusion part that protrudes convexly downwardly and is connected to the sub plate 54, and at least one notch may be formed in the safety vent around the protrusion part.

When gas is generated due to overcharging or abnormal operation of the secondary battery, the protrusion part is deformed upwardly by the pressure and separates from the sub plate while the safety vent is cut (e.g., bursts or tears) along the notch. The cut safety vent may prevent the secondary battery from exploding by allowing for the gas to be discharged to the outside.

The cap down 53 may be below the safety vent 52. The cap down 53 may have a first opening for exposing the protrusion part of the safety vent 52 and a second opening for gas discharge. The insulating member may be positioned between the safety vent 52 and the cap down 53 to insulate the safety vent 52 and the cap down 53.

The sub plate 54 may be under the cap down 53. The sub plate 54 may be fixed to a lower surface of the cap down 53 to block the first opening of the cap down 53, and the protrusion part of the safety vent 52 may be fixed to the sub plate 54. The first lead tab 35, which is drawn out from the electrode assembly 30, may be fixed to the sub plate 54. Accordingly, the cap up 51, the safety vent 52, the cap down 53, and the sub plate 54 may be electrically connected to the first electrode 30c of the electrode assembly 30.

The insulating plate 37 may be positioned to be in contact with the electrode assembly 30 below the beading part 13. The insulating plate 37 may have a tab opening through which the first lead tab 35 is drawn out. The cap assembly 50, which is electrically connected to the first electrode 30c by the first lead tab 35, may face the electrode assembly 30 with the insulating plate 37 interposed therebetween and may maintain a state of being insulated (e.g., electrically insulated) from the electrode assembly 30 by the insulating plate. Meanwhile, another insulating plate 36 may be included for insulation between the electrode assembly 30 and the bottom portion 38a of the case 38.

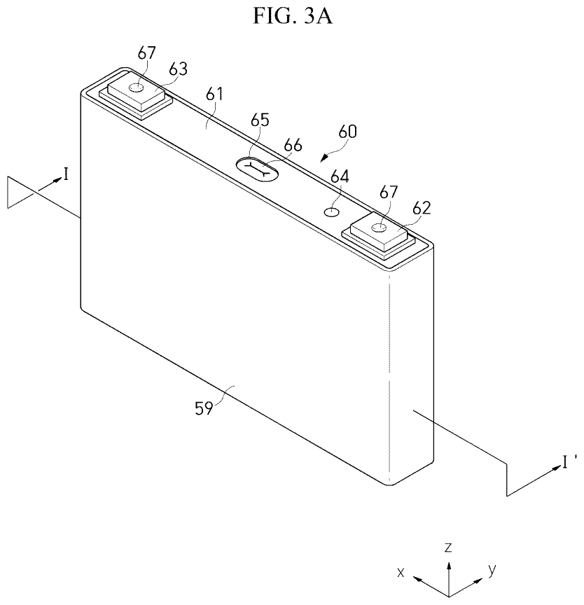

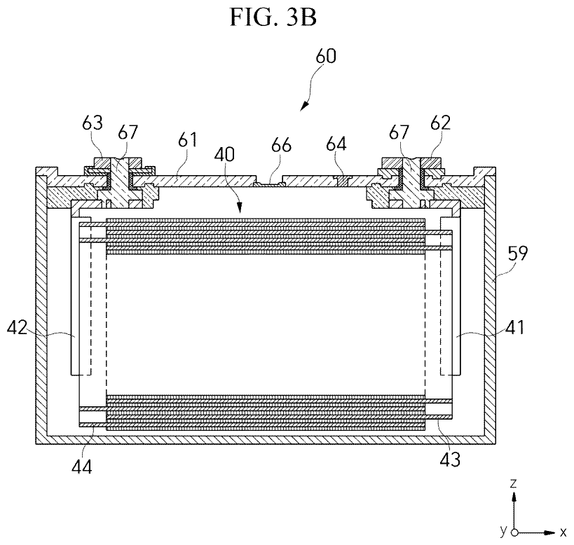

FIG. 3A is a top perspective view of a prismatic battery that can be used in an energy storage device.

A case 59 defines an overall appearance of the prismatic secondary battery, and may be made of a conductive metal, such as aluminum, aluminum alloy, or nickel-plated steel. In addition, the case 59 may provide a space for accommodating an electrode assembly therein.

A cap assembly 60 may include a cap plate 61 that covers the opening of the case 59. In some examples, the case 59 and the cap plate 61 may be made of a conductive material. Here, a first terminal 63 and a second terminal 62 may be electrically connected to respective positive and negative (or negative and positive) electrodes inside the case, and may be installed to protrude outward through the cap plate 61.

An electrolyte injection port 64 may be formed in the cap plate 61, a gas discharge hole 65 may be opened, and a vent, i.e., a gas discharge device 66 may be connected to the gas discharge hole 65. The gas discharge device 66 is opened by gas generated inside the battery and performs a degassing function.

FIG. 3B is a cross-sectional view taken along the line I-I′ of FIG. 3A, illustrating the internal configuration of a prismatic battery and the structure of the cap assembly 60.

An electrode assembly 40 may be formed by winding or stacking a stack of a first electrode plate, a separator, and a second electrode plate, which are formed as thin plates or films. When the electrode assembly 40 is a wound stack, a winding axis may be parallel to the longitudinal direction (e.g., the y direction) of the case 51. In some other embodiments, the electrode assembly 40 is a stack type rather than a winding type. The shape of the electrode assembly 40 may vary. In addition, the electrode assembly 40 may be a Z-stack electrode assembly in which a positive electrode plate and a negative electrode plate are inserted into both sides of a separator, which is then bent into a Z-stack. In addition, one or more electrode assemblies may be stacked such that long sides of the electrode assemblies are adjacent to each other and accommodated in the case, and the number of electrode assemblies in the case may vary. The first electrode plate of the electrode assembly may act as a negative electrode, and the second electrode plate may act as a positive electrode. Of course, the reverse is also possible.

The first electrode plate may be formed by applying (e.g., coating or depositing) a first electrode active material, such as graphite or carbon, onto a first electrode substrate formed of a metal foil, such as copper, a copper alloy, nickel, or a nickel alloy. The first electrode plate may include a first electrode tab 43 (e.g., a first uncoated portion), which is a region to which the first electrode active material is not applied. The first electrode tab 43 may act as a current flow path between the first electrode plate and the first current collector 41. In some embodiments, when the first electrode plate is manufactured, the first electrode tab 43 is formed by being cut in advance to protrude to one side of the electrode assembly 40, or the first electrode tab 43 protrudes to one side of the electrode assembly 40 more than (e.g., farther than or beyond) the separator without being separately cut.

The second electrode plate may be formed by applying a second electrode active material, such as a transition metal oxide, on a second electrode current collector formed of a metal foil, such as aluminum or an aluminum alloy, and the second electrode plate may include a second electrode tab 44 (or a second uncoated portion) that is a region to which the second electrode active material is not applied. The second electrode tab 44 may act as a current flow path between the second electrode plate and the second current collector 42. In some embodiments, the second electrode tab 44 may be formed by being cut in advance to protrude to the other side (e.g., the opposite side) of the electrode assembly when the second electrode plate is manufactured, or the second electrode plate may protrude to the other side of the electrode assembly more than (e.g., farther than or beyond) the separator without being separately cut.

The separator prevents or substantially reduces instances of a short circuit between the first electrode and the second electrode while allowing movement of lithium ions therebetween. The separator may be made of, for example, a polyethylene film, a polypropylene film, a polyethylene-polypropylene film, or the like.

In some embodiments, the electrode assembly 40 is accommodated in the case 10 along with an electrolyte.

In the electrode assembly 40, the first current collector 41 and the second current collector 42 may be welded and connected to the first electrode tab 43 extending from the first electrode plate and the second electrode tab 44 extending from the second electrode plate, respectively.

The first current collector 41 and the second current collector 42 are connected to the first terminal 63 and the second terminal 62 through connection members 67, respectively. In some embodiments, the connection members 67 may each have an outer peripheral surface that is threaded, and may be fastened to the first terminal 63 and the second terminal 62 by screwing. However, the connection members 67 may also be coupled to the first terminal 63 and the second terminal 62 by riveting or welding.

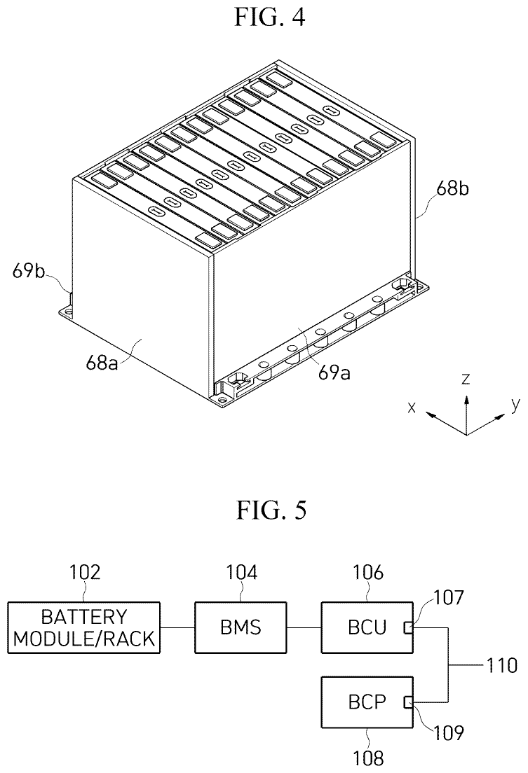

FIG. 4 is an exemplary view of a battery module in which batteries are arranged. In order to apply the present disclosure to an energy storage system (ESS), a battery module is manufactured by arranging and connecting a plurality of battery cells in a horizontal and/or vertical direction. The plurality of secondary batteries may be arranged in a space defined by a pair of facing end plates 68a and 68b and a pair of facing side plates 69a and 69b. The secondary batteries may be arranged in an arrangement (direction) and number to obtain desired voltage and current specifications.

The battery module illustrated in FIG. 4 may be a basic unit of the ESS.

The energy storage device may include a battery management system (BMS) for managing the battery. The BMS measures and determines in advance the voltage (V), current (I), temperature (T), etc. of the battery applied to electric vehicles or ESS by using sensors, and controls the battery so that it can perform optimally. The battery management device may include a detection device, a balancing device, and a control device.

The detection device may detect a state of a battery (e.g., voltage, current, temperature, etc.) to output state information indicating the state of the battery. The detection device may detect the voltage of each cell constituting the battery or of each battery module.

The detection device may detect current flowing through each battery module constituting the battery module or the battery pack. The detection device may also detect the temperature of a cell and/or module on at least one point of the battery and/or an ambient temperature.

The balancing device may perform a balancing operation of a battery module and/or cells constituting the battery module. The control device may receive state information (e.g., voltage, current, temperature, etc.) of the battery module from the detection device. The control device may monitor and calculate the state of the battery module (e.g., voltage, current, temperature, state of charge (SOC), life span (state of health (SOH)), etc.) on the basis of the state information received from the detection device. In addition, based on the state monitoring results, the control device may perform control functions (e.g. temperature control, balancing control, and charging/discharging control), protection functions (e.g. over-discharge, over-charge, and over-current prevention, short circuit, fire extinguishing functions, and the like), or the like. In addition, the control device may perform a wired or wireless communication function with an external device of the battery pack (e.g., a higher-level controller or vehicle, charger, power conversion system, etc.).

The control device may control charging/discharging operation and protection operation of the battery. To this end, the control device may include a charge/discharge control unit, a balancing control unit, and/or a protection unit.

The battery management system is a system that monitors the battery state and performs diagnosis and control, communication, and protection functions, and may calculate the charge/discharge state, calculate battery life or state of health (SOH), cut off, as necessary, battery power (e.g., relay control), control thermal management (e.g., cooling, heating, etc.), perform a high-voltage interlock function, and/or may detect and/or calculate insulation and short circuit conditions.

A relay may be a mechanical contactor that is turned on and off by the magnetic force of a coil or a semiconductor switch, such as a metal oxide semiconductor field effect transistor (MOSFET).

The relay control has a function of cutting off the power supply from the battery if (or when) a problem occurs in the vehicle and the battery system and may include one or more relays and pre-charge relays at the positive terminal and the negative terminal, respectively.

In the pre-charge control, there is a risk of inrush current occurring in the high-voltage capacitor on the input side of the inverter when the battery load is connected. Thus, to prevent inrush current when starting a vehicle, the pre-charge relay may be operated before connecting the main relay and the pre-charge resistor may be connected.

The high-voltage interlock is a circuit that uses a small signal to detect whether or not all high-voltage parts of the entire vehicle system are connected and may have a function of forcibly opening a relay if (or when) an opening occurs at even one location on the entire loop.

FIG. 5 illustrates a schematic configuration of an energy storage system (ESS) according to one or more embodiments of the present disclosure.

The ESS may be generally composed of a battery module/rack 102, a battery management system (BMS) 104, a battery control unit (BCU) 106, and a battery control panel (BCP) 108.

Here, the battery module/rack 102 may be a module as illustrated in FIG. 4 in which the batteries illustrated in FIGS. 1 to 3B are arranged or a rack installed in a container as illustrated in FIG. 6.

As described above, the BMS 104 may detect the voltages, currents, and temperatures of the battery cells and determine the states of charge (SOC) and/or the states of health (SOH) of the battery cells. In addition, the BMS may perform overcharge protection, overdischarging protection, overcurrent protection, overvoltage protection, overheating protection, cell balancing, and the like. The BMS 104 may be included in the BCU 106 or, for example, be separate from the BCU 106.

The BCU 106 may be responsible for electrical connection and disconnection of the battery module/rack 102, but other scenarios are possible. For example, the BCU 106 may control a charging/discharging operation, protection operation, or the like of the battery together with the BMS 104 or separately. The BCU 106 may be designed to perform different functions according to the specifications of the ESS.

The BCP 108 may be a unit for a user to control the execution of functions of the BCU 106 or display an operation state and may also function to collect connection cables from other equipment and integrally connect the connection cables to the BCU 106. Therefore, to externally connect the cable connected to the BCP 108 to the BCU 106, the cable 110 connected to a terminal 109 of the BCP 108 is fastened to a connector 107 attached to the BCU 106.

FIG. 6 is a plan view illustrating the inside of a container type energy storage system according to one or more embodiments of the present disclosure.

A plurality of racks 114 designed so that a battery module has a predetermined voltage and current capacity are installed inside a container 112.

The BCU 106 and the BCP 108 are installed at one side of the container 112, and the BMS and/or various auxiliary equipment are installed at the other side.

In this way, when the ESS is installed inside the container 112, spaces assigned to the BCU 106, the BCP 108, and the like other than the ESS, become narrow, thereby making installation and maintenance difficult. In particular, to fasten the cable to the connector attached to a rear of the BCU 106, the connector needs to be fastened in a narrow space 120 between the rear of the BCU 106 and the wall. A person may not enter the space 120, an arm may barely enter therein, and the space 120 is dark because light is blocked. Accordingly, it is difficult to accurately fasten the cable while visually checking the connector, and it is necessary to find an approximate position of the connector by relying on memory, and it may be difficult to apply a force required for fastening.

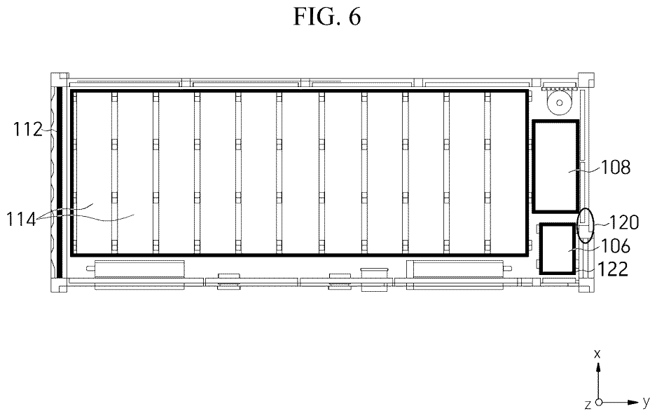

FIG. 7 illustrates a rear panel 122 of the BCU 106 according to an embodiment of the present disclosure. Installation brackets 124 protrude from left and right sides of the rear panel 122, but the arrangement may vary.

Two connectors 126 and 128 are attached to the panel 122, but other scenarios are possible. A first connector 126 may be a connector “P−” for a (−) power line, and a second connector 128 may be a connector “P+” for a (+) power line. In the present embodiment, the first and second connectors 126 and 128 may be receptacles (also known as female connectors), but may instead be “male” connectors. Cables to be connected to the first connector 126 and the second connector 128 may be two cables, each connected to one of counterpart connectors (e.g., a plug) for P− and P+ connection or one cable to which two corresponding plugs are connected.

A connector guide groove 130 is formed in a space between the first connector 126 and the second connector 128. In another example, only one connector may be attached to the panel 122, and the connector guide groove 130 may be formed adjacent to the connector.

The connector guide groove 130 may include a space formed in the panel, into which the counterpart connector to be fastened to the connector is inserted, and include guide walls 130a and 130b that guide the movement of the counterpart connector toward one of connectors 126 and 128, and end portions 131a and 131b at which the movement of the counterpart connector that has moved along the guide walls 130a and 130b is stopped.

The connector guide groove 130 functions to guide the counterpart connector to be fastened to a right (e.g., correct) position, i.e., the first connector 126 or the second connector 128. For example, when a worker inserts the counterpart connector to be fastened into the connector guide groove 130 and pushes the counterpart connector to the left or right side in a direction of arrow B to reach each of end portions 131a and 131b of the groove, the worker can know that the first connector 126 or the second connector 128 is positioned adjacent to that point without visual checking. Therefore, the end portions 131a and 131b of the connector guide groove 130 are preferably close, e.g., immediately adjacent, to the first connector 126 and the second connector 128. In other words, of the parts of the connector guide groove 130, the end portions 131a and 131b are closest to the first connector 126 and the second connector 128, respectively. In addition, a transverse width W of the connector guide groove 130, e.g., a distance between the guide walls 130a and 130b, is preferably greater than a corresponding width of the counterpart connector.

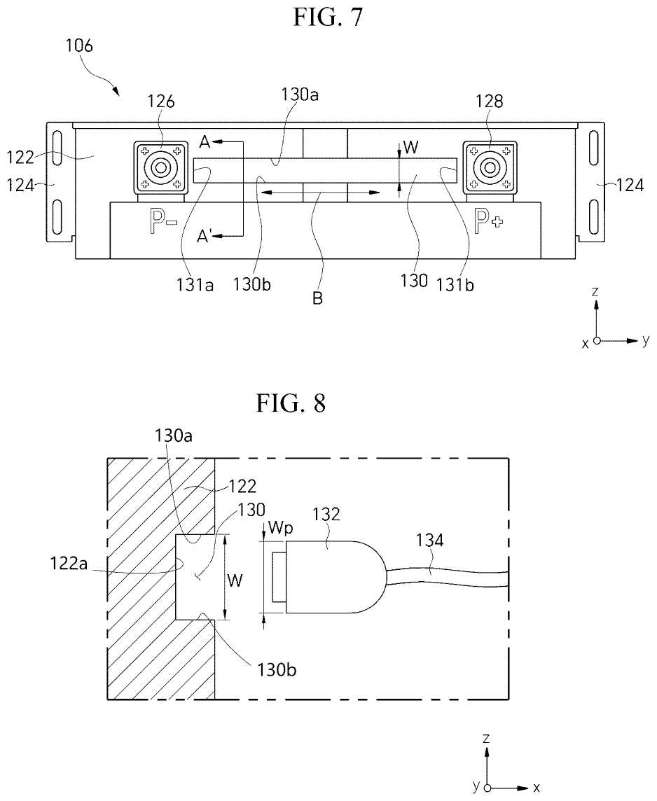

FIG. 8 is a transverse cross-sectional view of the connector guide groove 130 and is a cross-sectional view along line A-A′ in FIG. 7.

The connector guide groove 130 formed on the panel 122 of the BCU 106 has a quadrangular space formed by an inner surface (hereinafter referred to as a bottom surface 122a in FIG. 8) recessed into the panel 122 and the guide wall, and the counterpart connector 132 may be inserted into the connector guide groove 130 (also quadrangular). Here, “134” denotes a cable. In addition, the counterpart connector 132 may be a plug (a so-called male connector), but the connectors may vary. Here, the transverse width W of the connector guide groove 130 is also preferably greater than the transverse width Wₚ or diameter of the counterpart connector 132.

In order for the connector guide groove 130 to facilitate the guiding function of the counterpart connector, the cross-sectional shape and/or frontal shape of the connector guide groove 130 may be designed in various ways.

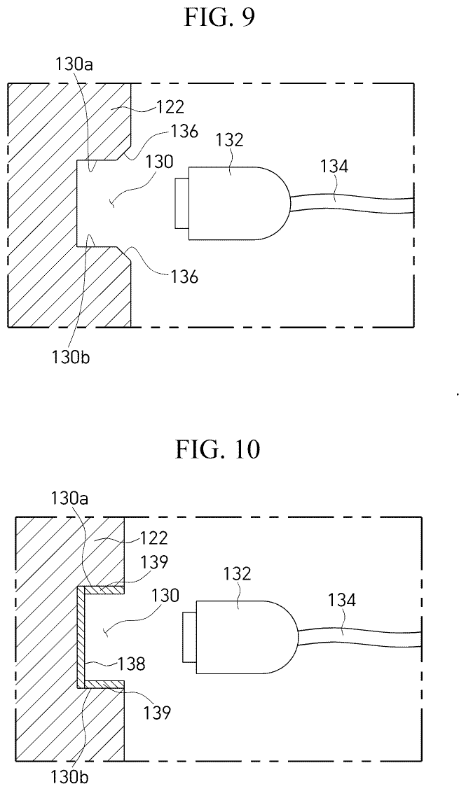

FIG. 9 is a transverse cross-sectional view of the connector guide groove 130 according to one or more other embodiments of the present disclosure.

When the counterpart connector 132 is inserted into the connector guide groove 130 and after inserted, slides laterally, chamfering machining 136 was performed on a boundary of the guide walls 130a and 130b to minimize damage caused by the counterpart connector 132 in contact with portions in which the grooves start to form in the guide walls 130a and 130b, that is, boundaries of the panel 122 and the guide walls 130a and 130b.

FIG. 10 is a transverse cross-sectional view of the connector guide groove 130 according to one or more embodiments of the present disclosure.

To minimize damage caused by the counterpart connector 132 in contact with the wall of the groove when the counterpart connector 132 is inserted into the connector guide groove 130 and after inserted, slides laterally, a shock-absorbing layer 138 is attached to or formed on the bottom surface of the connector guide groove 130. The shock-absorbing layer 138 may be implemented by attaching woven or non-woven fabric or being coated with Teflon or a synthetic resin, but the materials may vary. In one or more other embodiments, in addition to or instead of the bottom shock-absorbing layer 138 of the connector guide groove 130, a guide wall shock-absorbing layer 139 may be attached to or formed on the guide walls 130a and 130b. A material or application method of the guide wall shock-absorbing layer 139 may be similar to that of the bottom shock-absorbing layer 138.

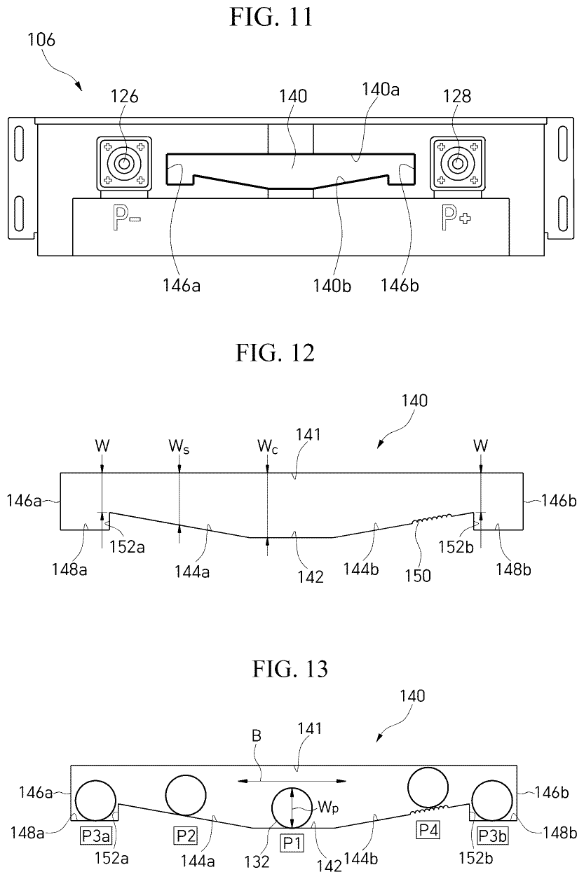

FIG. 11 is a front view of the connector guide groove 140 according to one or more other embodiments. In comparison to the connector guide groove 130 of FIG. 7, shapes of both end portions 146a and 146b are slightly different and an inclined surface is added to a guide portion. This will be described in detail with reference to the detailed description of FIGS. 12 and 13.

The connector guide groove 140 according to the present embodiment has different shapes of the guide walls 140a and 140b facing each other and connecting a first end portion 146a adjacent to the first connector 126 to a second end portion 146b adjacent to the second connector 128. For example, the first guide wall 140a may include a linear portion 141 connected to the first end portion 146a and the second end portion 146b, and the second guide wall 140b may include a linear portion 142 positioned at a central portion thereof, a first inclined portion 144a inclined to have a transverse width decreasing from the central portion to the first end portion 146a, a first stepped portion 152a at which the inclination of the first inclined portion 144a is stopped by meeting the first end portion 146a, a second inclined portion 144b inclined to have a transverse width decreasing from the central portion to the second end portion 146b, and a second stepped portion 152b at which the inclination of the second inclined portion 144b is stopped by meeting the second end portion 146b.

Here, the central portion may be present substantially at a midpoint between the first connector 126 and the second connector 128, and the connector guide groove 140 may have a left-right symmetrical structure with respect to the central portion. When only one connector is present, only a half of the connector guide groove 140 with respect to the central portion may be required.

In FIG. 12, a portion of the connector guide groove 140 having the smallest transverse width has a width W between the linear portion 141 of the first guide wall 140a and the first stepped portion 152a of the second guide wall 140b, and a width W between the linear portion 141 of the first guide wall 140a and the second stepped portion 152b of the second guide wall 140b. Accordingly, at least W of the transverse width of the connector guide groove 140 of FIG. 12 is preferably greater than the maximum width Wₚ (see FIGS. 8 and 13) of the counterpart connector 132.

A portion of the connector guide groove 140 having the greatest transverse width of FIG. 12 has a width W_{c} between the linear portion 141 of the first guide wall 140a and the linear portion 142 of the second guide wall 140b. Accordingly, the counterpart connector 132 can be most easily inserted into the groove at this portion. A width that varies between the widths W and W_{c} is denoted as Wₛ.

Referring to FIG. 13, a user may insert the counterpart connector 132 at a position P1 near the central portion of the connector guide groove 140 or at another random position while holding the counter connector 132 in his or her hand, and slide P2 the counterpart connector 132 in a space having the width Wₛ gradually increasing along the inclined portions 144a and 144b in a left or right direction (see arrow B) to move the counterpart connector 132 toward the first connector 126 or the second connector 128, and then when the counterpart connector is close to the first end portion 146a or the second end portion 146b, the inclination is ended and the counterpart connector 132 may be seated on seating portions 148a and 148b formed on the end portions 146a and 146b, respectively, along the first stepped portion 152a or the second stepped portion 152b (P3a, P3b). Here, a space between the first end portion 146a and the first stepped portion 152a is a first seating portion 148a, and a space between the second end portion 146b and the second stepped portion 152b is a second seating portion 148b. In FIG. 12, when the counterpart connector 132 reaches the first end portion 146a and the second end portion 146b and is seated on each of the seating portions 148a and 148b, the user can know that the counterpart connector 132 reaches the end portions 146a and 146b because the counterpart connector 132 is not pushed in an opposite direction unless the counterpart connector 132 is pulled out of the groove by each of the stepped portions 152a and 152b. The user can easily pull out the counterpart connector 132 from each of the end portions 146a and 146b and fasten the counterpart connector 132 to the adjacent first connector 126 or second connector 128.

Meanwhile, according to some other embodiments of the present disclosure, as illustrated in FIGS. 12 and 13, before the second inclined portion 144b of the second guide wall 140b ends in front of the second end portion 146b, an uneven portion 150 (e.g., jagged portion) is present on a surface of the second inclined portion 144b. The uneven portion 150 is intended to enable the user to identify the left and right directions of the connector guide groove 140. Therefore, the uneven portion 150 is preferably present at only the left or right side of the connector guide groove 140. When the user slides the counterpart connector 132 and then meets the uneven portion 150, he or she feels vibrations P4, and the worker who feels the vibrations can determine whether the corresponding moving direction is the intended direction.

Units such as a battery management system (BMS), a battery control unit (BCU), and a battery control panel (BCP) may require connector fastening, and when the units are installed inside a container, an available space is reduced, and thus there is a difficulty that connector fastening needs to be done in a narrow space between the rear of the unit and a wall.

The present disclosure is directed to providing a method of facilitating connector fastening of units that require the connector fastening, such as a battery management system (BMS), a battery control unit (BCU), a battery control panel (BCP), etc., which may be included in an energy storage system.

In some embodiments, the connector guide groove may be a groove into which a counterpart connector fastened to the connector is inserted, the guide wall may guide the movement of the counterpart connector toward the connector, and the end portion may be a point at which the movement of the counterpart connector that has moved along the guide wall is stopped.

According to the present disclosure, connectors of units such as a BMS, a BCU, and a BCP of an energy storage system installed in a narrow space such as a container can be easily fastened using only one hand without visual checking, thereby improving workability and increasing space utilization.

Although the present disclosure has been described above with respect to embodiments thereof, the present disclosure is not limited thereto. Various modifications and variations can be made thereto by those of ordinary skill in the art within the spirit of the present disclosure as defined by the appended claims and their equivalents. For example, although the above-described embodiments have described the BCU, which is one of the components of the ESS, the present disclosure can be applied to not only other components, but also other devices requiring connector fastening than components of the ESS, a connector mounting panel, and the like.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated.

Accordingly, it will be understood by those of skill in the art that various changes in form and details may be made without departing from the spirit and scope of the present invention as set forth in the following claims.

What is claimed is:

1. An apparatus for connector fastening, comprising:
a panel;
a connector attached to the panel; and
a connector guide groove adjacent to the connector, the connector guide groove being in the panel,
wherein the connector guide groove comprises a bottom surface recessed inward from a surface of the panel, a guide wall connecting the bottom surface to the surface of the panel, and an end portion connected to the guide wall, the end portion being closest to the connector.

2. The apparatus for connector fastening as claimed in claim 1, wherein:
the connector comprises a first connector and a second connector, and
the connector guide groove is between the first connector and the second connector.

3. The apparatus for connector fastening as claimed in claim 1, wherein the panel, the connector, and the connector guide groove are in a battery control unit.

4. The apparatus for connector fastening as claimed in claim 1, wherein the bottom surface and the guide wall of the connector guide groove create a space that has a quadrangular shape.

5. The apparatus for connector fastening as claimed in claim 1, wherein a boundary between the guide wall of the connector guide groove and the panel comprises a chamfering machined portion.

6. The apparatus for connector fastening as claimed in claim 1, further comprising a shock-absorbing layer on the bottom surface of the connector guide groove.

7. The apparatus for connector fastening as claimed in claim 1, wherein the end portion of the connector guide groove has a quadrangular shape.

8. The apparatus for connector fastening as claimed in claim 1, wherein the guide wall of the connector guide groove comprises an inclined portion.

9. The apparatus for connector fastening as claimed in claim 1, wherein the guide wall of the connector guide groove comprises a stepped portion where the guide wall meets the end portion.

10. The apparatus for connector fastening as claimed in claim 1, wherein the guide wall of the connector guide groove comprises an uneven portion.

11. A battery control unit, comprising:
a connector attached to a panel; and
a connector guide groove adjacent to the connector, the connector guide groove being in the panel,
wherein the connector guide groove comprises a bottom surface recessed inward from a surface of the panel, a guide wall connecting the bottom surface to the surface of the panel, and an end portion connected to the guide wall, the end portion being closest to the connector relative to other parts of the connector guide groove.

12. The battery control unit as claimed in claim 11, wherein:
the connector comprises a first connector and a second connector, and
the connector guide groove is between the first connector and the second connector.

13. The battery control unit as claimed in claim 11, wherein the bottom surface and the guide wall of the connector guide groove create a quadrangular space.

14. The battery control unit as claimed in claim 11, wherein a boundary of the guide wall of the connector guide groove comprises a chamfering machined portion.

15. The battery control unit as claimed in claim 11, further comprising a shock-absorbing layer on the bottom surface of the connector guide groove.

16. The battery control unit as claimed in claim 11, wherein the end portion of the connector guide groove has a quadrangular shape.

17. The battery control unit as claimed in claim 11, wherein the guide wall of the connector guide groove comprises an inclined portion.

18. The battery control unit as claimed in claim 11, wherein the guide wall of the connector guide groove comprises a stepped portion where the guide wall meets the end portion.

19. The battery control unit as claimed in claim 11, wherein the guide wall of the connector guide groove comprises an uneven portion.

20. A connector mounting panel, comprising:
a connector; and
a connector guide groove adjacent to the connector,
wherein the connector guide groove comprises a bottom surface recessed inward from a surface, a guide wall connecting the bottom surface to the surface, and an end portion connected to the guide wall, the end portion being closest to the connector.
